(19) United States
(12) Patent Application Publication
(10) Pub. No.: US 2016/0215900 A1
(43) Pub. Date: Jul. 28, 2016

(54) Rotary Stem Design for Valve

(71) Applicant: Control Components, Inc., Rancho Santa Margarita, CA (US)

(72) Inventors: Timo Kubota, Rancho Santa Margarita, CA (US); Ray Newton, Rancho Santa Margarita, CA (US); Peter Ho, Rancho Santa Margarita, CA (US)

(21) Appl. No.: 15/000,327

(22) Filed: Jan. 19, 2016

Related U.S. Application Data
(60) Provisional application No. 62/106,432, filed on Jan. 22, 2015.

(51) Int. Cl. F16K 31/50; F16K 1/02

(52) U.S. Cl. CPC F16K 31/50; F16K 1/02

(57) ABSTRACT

In accordance with the present invention, there is provided a control valve comprising there is provided a control valve comprising a valve body having a valve bonnet which is cooperatively engaged thereto. The body and the bonnet collectively define a housing which accommodates a valve trim comprising a flow control element and a complementary valve plug. The plug is attached to a reciprocally rotatable valve stem of the control valve. In the control valve, the reciprocal rotary movement of the valve stem of the valve through the packing area thereof, rather than the reciprocal liner movement of the valve stem through such packing area, is used to facilitate the reciprocal linear movement of the plug cooperatively engaged to the stem. The use of a rotary stem design instead of a liner reciprocating stem is operative to reduce fugitive emissions from the valve.

### CROSS-REFERENCE TO RELATED APPLICATIONS

The present application claims priority to U.S. Provisional Patent Application Ser. No. 62/106,432 entitled ROTARY STEM DESIGN FOR A VALVE filed Jan. 22, 2015.

### STATEMENT RE: FEDERALLY SPONSORED RESEARCH/DEVELOPMENT

Not Applicable

### BACKGROUND OF THE INVENTION

1. Technical Field of the Invention:

The present invention relates generally to flow control devices and, more particularly, to a control valve wherein the reciprocal rotary movement of the valve stem of the valve through the packing area thereof, rather than the reciprocal liner movement of the valve stem through such packing area, is used to facilitate the reciprocal linear movement of the plug cooperatively engaged to the stem, the use of a rotary stem design instead of a liner reciprocating stem being operative to reduce fugitive emissions form the valve.

2. Description of the Related Art:

In the prior art, one currently know control valve includes a plug or spindle that is linearly displaced during normal operation of the valve. Within these valves, which are often referred to as linear displacement valves, the plug is disposed and moveable within a disc stack or valve cage which defines a multiplicity of tortuous and/or non-tortuous fluid passageways. The valve trim of these valves comprises the combination of the plug and the valve cage. Certain linear displacement valves are configured for “over plug flow” wherein fluid flows radially inward into the interior of the valve cage from the exterior thereof, with the fluid undergoing a pressure drop as a result of the flow through the passageways of the valve cage. In this arrangement, the valve is opened by lifting the plug off a seat ring which thus allows the fluid to flow from the interior of the valve cage and out of the valve via the unblocked seat ring. Conversely, movement of the seating surface of the plug into sealed engagement with the complimentary seating surface of the seat ring facilitates a closed or shut-off condition for the valve.

As an alternative to over plug flow, other linear displacement valves are configured for “under plug flow” wherein fluid flows axially upwardly into the interior of the valve cage to the exterior thereof, with the fluid undergoing a pressure drop as a result of the flow of the fluid radially outwardly through the fluid passageways of the valve cage. In this arrangement, the valve is opened by lifting the plug off of the aforementioned seat ring, which thus allows the fluid to flow into the interior of the valve cage and thereafter radially outwardly through the fluid passageways of the valve cage. Conversely, the movement of the seating surface of the plug into sealed engagement with the complimentary seating surface of the seat ring facilitates a closed or shut-off condition for the valve.

In currently known linear displacement control valves, the plug is often attached to one end of elongate shaft or valve stem, the opposite end of which is operatively coupled to an actuator. The actuator is itself operative to facilitate the reciprocal linear movement of the valve stem, and hence the plug, though a “stroke” as results in the movement of the plug between the open and closed positions described above.

Linear displacement control valves are often used to control flow and pressure in a process. In certain applications, these valves must adhere to strict fugitive emission specifications to minimize leakage attributable to the valve stem seal/packing, with allowable valve stem packing leakage rates being very low. In these regard, standards/regulations have been enacted in various jurisdictions throughout the world which define the maximum concentration level of pollutants that can be detected in the air in an industrial setting and proximate valves located therein.

When fugitive emissions standards are applied to many currently known reciprocating, linear displacement control valves, the ability of such valves to meet these standards is reduced since the design incorporates a reciprocating valve stem that has a long stroke. In greater detail, stems that reciprocate tend to produce more fugitive emissions because of increased stem wear and seal/packing wear. The stem also tends to act as a pump. In this regard, the small imperfections in the stem often provide a home for gas molecules to reside therein while the stem is being stroked through the valve packing set. Once these gas molecules are outside of the pressure boundary of the valve, the gas leaves the stem and enters the atmosphere. Another deficiency of the aforementioned reciprocating designs is that the stem must have a fine finish on its entire contact area with the packing, thus increasing its manufacturing cost. The present invention addresses the aforementioned fugitive emission deficiencies of currently known reciprocating, linear displacement control valves by providing a valve design wherein the reciprocal rotary movement of the stem through the packing area of the valve, rather than the reciprocal liner movement thereof through such packing area, is used to facilitate the reciprocal linear movement of the plug cooperatively engaged to the stem. In this regard, the combination of a rotary stem/packing with a reciprocating plug which moves through its stroke makes it possible to achieve lower fugitive emissions while maintaining the basic function of the valve. These as well as other features of the present invention will be described in more detail below.

### BRIEF SUMMARY OF THE INVENTION

In accordance with the present invention, there is provided a control valve comprising a valve body having a valve bonnet which is cooperatively engaged thereto. The body and the bonnet collectively define a housing which accommodates a valve trim comprising a flow control element and a complementary valve plug. The plug is attached to a reciprocally rotatable valve stem of the control valve.

In the control valve, the plug and the stem are threadably engaged to each other. In greater detail, the stem is formed to include a male ACME thread at the end portion thereof opposite that engaged to the actuator. The actuator is operative to facilitate the selective rotation of the stem in either a clockwise or counter-clockwise direction. The plug is formed to include a complimentary, internally threaded bore which accommodates the threaded portion of the stem. The threaded engagement of the stem to the plug allows for the conversion of the stem's rotary motion to a linear reciprocating motion of the plug. By rotating the stem with the rotary actuator, the plug will reciprocate in the trim and control flow/pressure through the valve.

The effective transfer of the rotational energy of the stem to the plug in the control valve of the present invention requires that plug not be allowed to rotate. In this regard, the control valve is preferably outfitted with at least one and preferably several anti-rotation keys which are used to keep the plug rotationally stable and further to provide some measure of guiding to the plug. In greater detail, the anti-rotation keys are disposed in the end portion of the plug opposite that which is normally brought into sealed engagement with the seating surface of the valve seat ring. The anti-rotation keys protrude from the outer diameter of the plug, with such protruding portions residing and being slidably movable in respective ones of elongate grooves or channels cut within the inner diameter of the valve bonnet. The anti-rotation keys also serve the function of stabilizing the plug against vibration during operation of the valve.

The control valve of the present invention is further preferably outfitted with at least one, and preferably several, wiper rings. In greater detail, the wiper rings are also disposed in the end portion of the plug opposite that which is normally brought into sealed engagement with the seating surface of the valve seat ring, the wiper rings protruding from the inner diameter of the plug at one end of the ACME threads formed in the bore thereof into sliding engagement with the outer surface of the stem. The wiper rings are operative to prevent debris from entering the ACME threads and potentially causing damage thereto.

The control valve of the present invention further comprises a guide bushing which is preferably outfitted with a guide, the preferred material for such guide being PTFE. In greater detail, the plug is reciprocally movable with the guide bushing, with the guide extending about the inner diameter of the guide bushing into direct, sliding engagement with the outer diameter of the plug. The guide is operative to keep the plug centered and add stability thereto during the movement thereof between the open and closed positions.

The present invention is best understood by reference to the following detailed description when read in conjunction with the accompanying drawings.

### BRIEF DESCRIPTION OF THE DRAWINGS

These, as well as other features of the present invention, will become more apparent upon reference to the drawings wherein:

FIG. 1 is a cross-sectional view of a control valve constructed in accordance with the present invention, illustrating the plug thereof in a closed position;

FIG. 2 is an enlargement of Section A shown in FIG. 1, depicting the details of the threaded engagement of the stem of the valve to the plug thereof as allows for the conversion of the rotary motion of the stem to the linear motion of the plug;

FIG. 3 is an enlargement of Section B shown in FIG. 1, depicting the details of the anti-rotation keys used to prevent the rotation of and provide stability to the plug;

FIG. 4 is an enlargement of Section C shown in FIG. 1, depicting the details of the wiper rings used to prevent debris from entering the ACME threads of the stem and plug; and

FIG. 5 is an enlargement of Section D shown in FIG. 1, depicting the details of the guide bushing/guide used to provide guiding and stability to the plug.

Common reference numerals are used throughout the drawings and detailed description to indicate like elements.

### DETAILED DESCRIPTION OF THE INVENTION

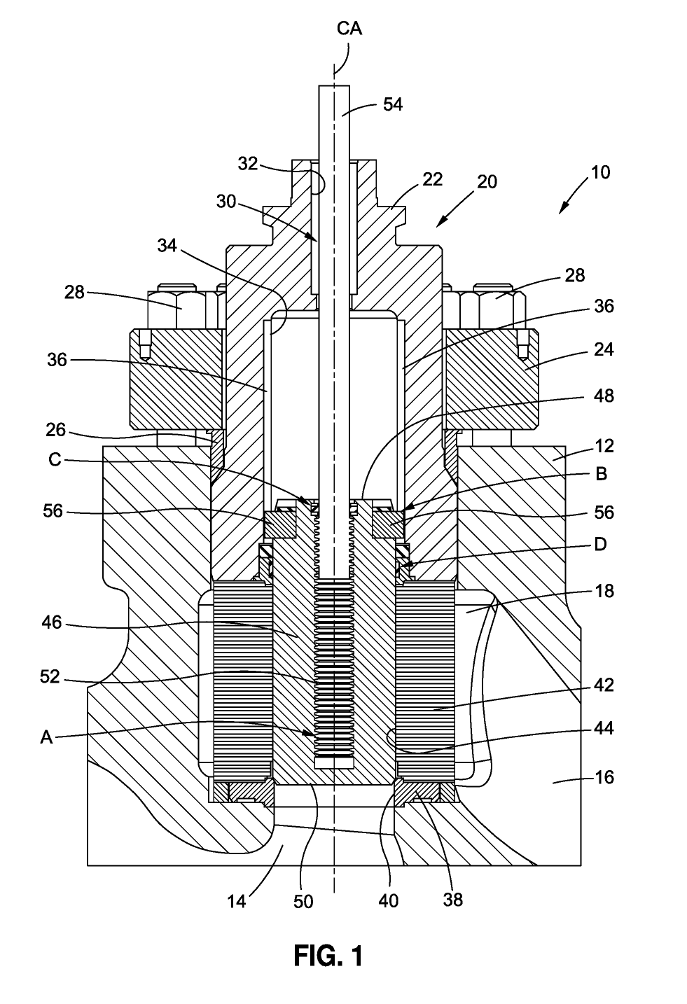

Referring now to the drawings wherein the showings are for purposes of illustrating a preferred embodiment of the present invention only, and not for purposes of limiting the same, FIG. 1 is a cross-sectional views of a control valve 10 constructed in accordance with the present invention. As will be described in more detail below, the valve 10 is shown in FIG. 1 in a closed or shut-off position.

The valve 10 comprises a valve body 12 which defines an inflow passage 14 and an outflow passage 16. The inflow and outflow passages 14, 16 each fluidly communicate with an interior chamber or valve gallery 18 defined by the body 12. In addition to the body 12, the valve 10 includes a bonnet 20 which is attached to the body 12 and encloses the gallery 18. The body 12 and the bonnet 20 collectively define a housing of the control valve 10. As shown in FIG. 1, the bonnet 20 is depicted as having a two-piece construction, comprising a main body member 22 and a flange member 24 which circumvents the main body member 22. An engagement ring 26 is partially captured between an exterior surface portion of the main body member 22 and an interior surface portion of the body 12, the engagement ring also being engaged by and acted upon by the flange member 24. In this regard, as also seen in FIG. 1, the attachment of the bonnet 20 to the body 12 is preferably facilitated through the use of mechanical fasteners 28 comprising a nut and bolt combination, the fasteners 28 passing through the flange member 24 and into the body 12. In this regard, the tightening of the fasteners 28 results in the flange member 24 of the bonnet 20 acting against the engagement ring 26 in manner strengthening the interference fit between the body 12 and the main body member 22 of the bonnet 20.

In the valve 10, the main body member 22 of the bonnet 20 defines a bore 30 which extends axially therethrough. The bore 30 is not of uniform inner diameter. Rather, the bore 30 defines several sections which each have a generally circular cross-sectional configuration and are of differing inner diameter. The two most prevalent of these sections are a first section 32 and a second section 34, the diameter of the second section 34 substantially exceeding that of the first section 32. Disposed within the interior surface of the main body member 22 defining the second section 34 of the bore 30 is at least one, and preferably several, elongate channels or grooves 36. In a preferred implementation of the valve 10, two grooves 36 are disposed in the interior surface of the main body member 22 in diametrically opposed relation to each other, each of the grooves 36 extending along the length of the second section 34 in generally parallel relation to a central axis CA defined by the valve 10. The use of the grooves 36 will be described in more detail below. As is apparent from FIG. 1, the axis of the bore 30 is coaxially aligned with the central axis CA.

Disposed within the gallery 18 of the body 12 is an annular seat ring 38. The seat ring 38 defines a circularly configured inflow opening 40, the top end of which (when viewed from the perspective shown in FIG. 1) is circumvented by a tapered seating surface. The seat ring 38 is oriented within the body 12, and in particular the gallery 18 thereof, such that the inflow opening 40 is coaxially aligned with the inflow passage 14.

In addition to the seat ring 38, disposed within the gallery 18 is a flow control element 42. The flow control element 42 has an annular, generally cylindrical configuration, and defines a central bore 44 which extends axially therethrough and has a generally circular cross-sectional configuration. The central bore 44 of the flow control element 42 is coaxially aligned with the bore 30 of the main body member 22 of the bonnet 20, with the aligned axes of the bores 30, 44 each extending along the central axis CA of the valve 10. The flow control element 34 also includes a multiplicity of tortuous and/or non-tortuous fluid energy dissipating flow passageways extending radially therethrough (i.e., between the inner and outer circumferential surfaces thereof). One end of each of these flow passageways fluidly communicates with the bore 44, with the opposite end fluidly communicating with the gallery 18.

When viewed from the perspective shown in FIG. 1, the bottom surface of the flow control element 42 is cooperatively engaged to the top surface of the seat ring 38. In addition, the flow control element 34 is positioned within the gallery 18 and relative to the seat ring 38 such that the bore 44 thereof is further coaxially aligned with the inflow opening 40 of the seat ring 38, and hence the inflow passage 14 of the valve body 12. Thus, along with the axes of the bores 30, 44, the axis of the inflow opening 40 also extends along the central axis CA of the valve 10. The flow control element 42 of the control valve 10 of the present invention may be fabricated through the use of a direct metal laser sintering (DMLS) process as is described with particularity in Applicant's U.S. Pat. No. 8,826,938 entitled DIRECT METAL LASER SINTERED FLOW CONTROL ELEMENT issued Sep. 9, 2014, the entirety of which is incorporated herein by reference. The use of the DMLS process to facilitate the fabrication of the flow control element 42 could facilitate the creation of more intricate and complex flow passages therein. Such increased intricacy/complexity provides better flow range/rangeability within the control valve 10. However, those of ordinary skill in the art will recognize that the flow control element 42 may alternatively comprise a more conventional disc stack or valve cage as opposed to be fabricated through the use of the aforementioned DMLS process.

The control valve 10 constructed in accordance with the present invention further comprises an elongate, generally cylindrical plug 46. When viewed from the perspective shown in FIG. 1, the plug 46 defines a top end 48 and an opposed bottom end 50. Disposed and extending axially within the plug 46 is an elongate plug bore 52 which has a generally circular cross-sectional configuration. One end of the bore 52 extends to the top end 48, with the opposite end of the bore 52 terminating short of the bottom end 50, the bore 52 thus not extending all the way through the plug 46. The outer diameter of the plug 46 is slightly less than that of the bore 44 defined by the flow control element 42. In addition, within the valve 10, the axis of the bore 52 is coaxially aligned with the axes of the bores 30, 44 and inflow opening 40, and thus also extends along the central axis CA of the valve 10. As will be described in more detail below, during operation of the valve 10, the plug 46 is reciprocally movable between open and closed positions. When in its closed position, the majority of the length of the plug 46 resides within the bore 44 of the flow control element 42, though a smaller portion of the length of the plug 46 resides within the second section 34 of the bore 30. When the plug 46 is actuated to an open position, the amount of the length thereof advanced into the second section 34 of the bore 30 increases in proportion to the amount of the length thereof removed from within the bore 44 of the flow control element 42. However, over the entire range of movement of the plug 46, at least a portion of the length thereof remains within the bore 44 of the flow control element 42.

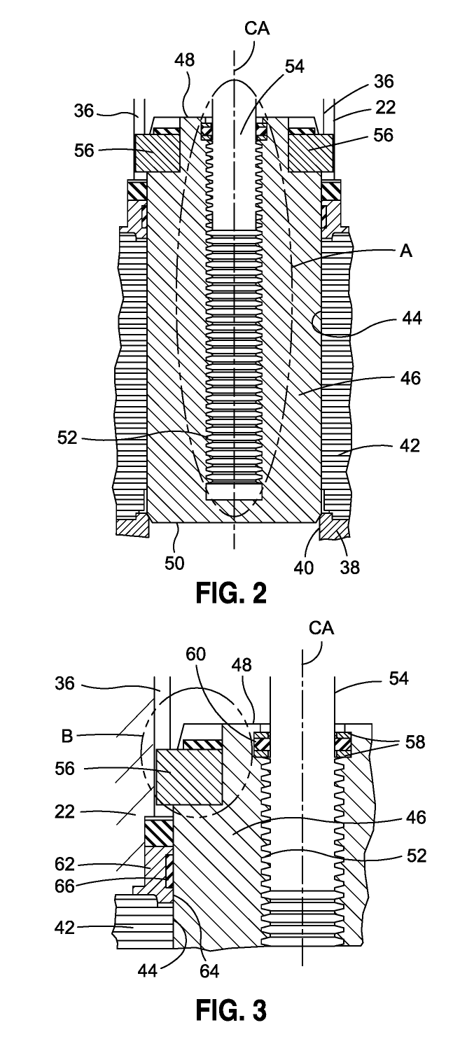

As shown with particularity in FIGS. 1 and 2, in accordance with the present invention, the plug 46 is preferably formed such that the majority of the length of the bore 52 defined thereby is internally threaded (i.e., formed to include female ACME threads). As is most apparent from FIG. 1, in the plug 46, only two small segments of the bore 52, one of which is proximate the closed end thereof and the other of which extends to and is proximate the top end 48, are devoid of the female threads. The use of the female threads will be described in more detail below.

In the valve 10, the plug 46 is operatively coupled to one end portion (i.e., the lower end portion when viewed from the perspective shown in FIG. 1) of an elongate stem 54 of the control valve 10. The stem 54 is advanced through the bore 30 defined by the main body member 22 of the bonnet 20. Though not shown with particularity in FIG. 1, is contemplated that a portion of the stem 54 protruding from the main body member 22 of the bonnet 20 may be mechanically coupled to an actuator which is operative to selectively rotate the stem 54 in either a clockwise or counter-clockwise direction relative to the body 12 and bonnet 20 about the central axis CA. The stem 54 has a generally circular cross-sectional configuration, and defines an axis which is coaxially aligned with the axes of the bores 30, 44, 52 and inflow opening 40, and thus also extends along the central axis CA of the valve 10.

As seen in FIGS. 1-5, the lower end portion of the stem 54 is formed to include male ACME threads configured to be complimentary to the female threads formed within the bore 52 of the plug 46. In this regard, in the control valve 10, the plug 46 and the stem 54 are threadably engaged to each other via the advancement of the externally threaded lower end portion of the stem 54 into the complementary, internally threaded bore 52 of the plug 46. As indicated above, it is contemplated that the actuator which will be used in conjunction with the valve 10 will be operative to facilitate the selective rotation of the stem 54 in either a clockwise or counter-clockwise direction. The threaded engagement of the stem 54 to the plug 46 allows for the conversion of the rotary motion of the stem 54 to a linear reciprocating motion of the plug 46 as facilitates the movement thereof between its open and closed or shut-off positions. In this regard, by rotating the stem 54 with the rotary actuator, the plug 46 will reciprocate in the flow control element 42 and control flow/pressure through the valve 10. As is apparent from the foregoing, the reciprocal rotary movement of the stem 54 through the packing area of the valve 10 (which, though not shown, typically resides within the first section 32 of the bore 30), rather than the reciprocal liner movement thereof through such packing area, is used to facilitate the reciprocal linear movement of the plug 46 cooperatively engaged to the stem 54. In this regard, the combination of a rotary stem 54/packing with a reciprocating plug 46 makes it possible to achieve lower fugitive emissions while maintaining the basic function of the valve 10. Those of ordinary skill in the art will recognize that different thread types other than for ACME, such as ball screws or roller screws, may alternatively be integrated into the plug 46 and stem 54 without departing from the spirit and scope of the present invention. Further, it is contemplated that the bore 52 may extend axially through the entirety of the 46, rather than terminating short of the bottom end 50 as indicated above. In this variant, the stem 54 could be advanced all the way through the plug 46 to protrude from the bottom end 50 thereof to provide enhanced stability.

In the control valve 10, the effective transfer of the rotational energy of the stem 54 to the plug 46 requires that plug 46 not be allowed to rotate. In this regard, the control valve 10 is preferably outfitted with at least one and preferably several anti-rotation keys 56 which are shown with particularity in FIGS. 1-3, and are used to keep the plug 46 rotationally stable and further to provide some measure of guiding to the plug 46. In greater detail, the control valve preferably includes two (2) anti-rotation keys 56 which are disposed in diametrically opposed relation to each other, and protrude from the outer diameter of the plug 46 in relative close proximity to the top end 48 thereof. In this regard, the plug 46 is oriented relative to the main body member 22 of the bonnet 20, and in particular the second section 34 of the bore 30 defined thereby, such that the anti-rotation keys 56 are advanced into, and slidably accommodated by, corresponding ones of the grooves 36 formed in the interior surface of the main body member 22 defining the second section 34 of the bore 30. As indicated above, the anti-rotation keys 54 also serve the function of stabilizing the plug 46 against vibration during operation of the valve 10. Those of ordinary skill in the art will recognize that the valve 10 may be outfitted with greater or fewer than two ant-rotation keys 56, in shapes differing from that shown in FIGS. 1-3, without departing from the spirit and scope of the present invention. Though not shown, it is contemplated that in a variant of the valve 10, the anti-rotation keys 54 may be rigidly affixed to the main body member 22 of the bonnet 20 so as to protrude from the interior surface of the main body member 22 into the second section 34 of the bore 30 defined thereby. In this variant, the anti-rotation keys 56 would be advanced into and slidably accommodated by corresponding ones of a pair of complimentary grooves formed in the exterior surface of the plug 46.

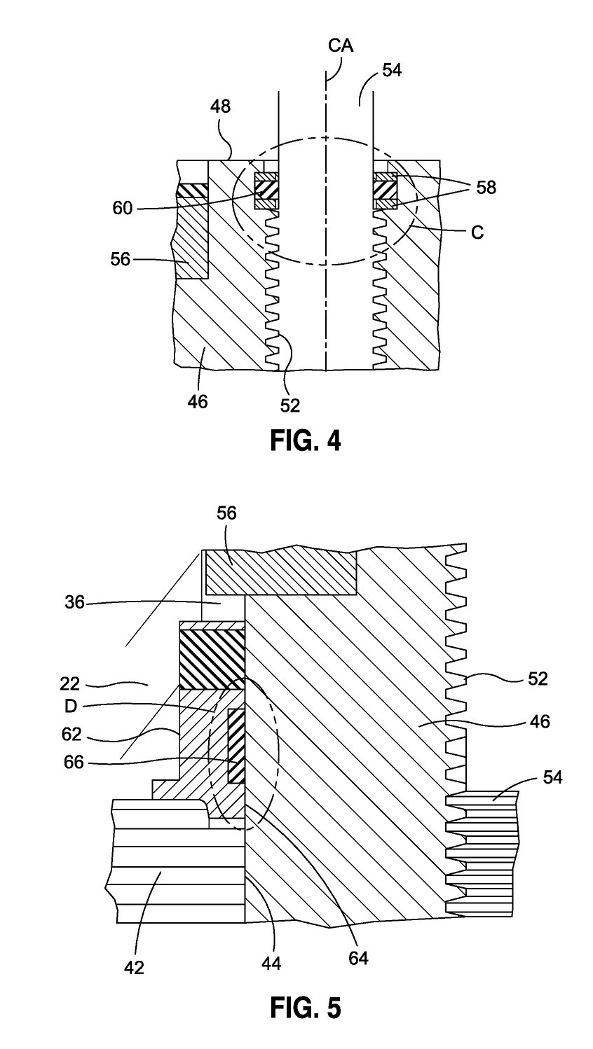

The control valve 10 is further preferably outfitted with at least one, and preferably several, annular wiper rings 58 which are shown with particularity in FIG. 4. In greater detail, the control valve preferably includes two (2) wiper rings 58 which are provided in a stacked arrangement and protrude from the inner diameter of the plug 46 (defining the bore 52) in close proximity to the top end 48 of the plug 46. In this regard, portions of the wiper rings 58 protrude from that segment of the bore 52 which extends to and is proximate the top end 48, and is devoid of the female threads. Within the valve 10, the wiper rings 58 are sized so as to further extend into sliding engagement with the outer surface of the stem 54 which is rotatable within the wiper rings 58. The wiper rings 58 are operative to prevent debris from entering the male and female ACME threads of corresponding ones of the plug 46 and stem 54, and potentially causing damage thereto. As shown in FIG. 4, it is contemplated that the wiper rings 58 may optionally be separated from each other by an ancillary sealing structure, such as an O-ring 60. Those of ordinary skill in the art will recognize that the valve 10 may be outfitted with greater or fewer than two wiper rings 58, in shapes differing from that shown in FIG. 4, without departing from the spirit and scope of the present invention.

Referring now to FIG. 5, the control valve 10 of the present invention further comprises an annular guide bushing 62 which defines a bore 64 extending axially therethrough. The bore 64 defines an axis which is coaxially aligned with the axes of the bores 30, 44, 52 and inflow opening 40, as well as the axis of the stem 54, and thus also extends along the central axis CA of the valve 10. The diameter of the bore 64 is preferably about the same as that of the second section 34 of the bore 30, as well as the bore 44 of the flow control element 42. Additionally, when viewed from the perspective shown in FIG. 1, the bottom end of the guide bushing 62 is cooperatively engaged to the top end of the flow control element 42. The guide bushing 62 further resides within the bore 30 of the main body member 22 between the second section 34 and the lower, distal rim of the main body member 22 which abuts the top end of the flow control element 42.

The guide bushing 62 is preferably outfitted with an annular guide 66, the preferred material for such guide 66 being PTFE, though other materials are considered to be within the spirit and scope of the present invention. The guide 66 extends about and protrudes slightly radially inwardly from the interior surface or inner diameter of the guide bushing 62 defining the bore 64 thereof. In the valve 10, the guide bushing 62 circumvents the plug 46, such that the plug 46 is reciprocally movable linearly with the guide bushing 62 as a result of the rotation of the stem 54. The guide 66, which extends about the inner diameter of the guide bushing 62 into direct, sliding engagement with the outer diameter of the plug 46, is operative to keep the plug 46 centered and to add stability thereto during the movement thereof between the open and closed positions.

As indicated above, the valve 10, and in particular the plug 46 thereof, is shown in its closed or shut-off position in FIG. 1. When the plug 46 is in the closed position, a seating surface circumventing the bottom end 50 thereof is firmly seated and sealed against the complimentary seating surface defined by the seat ring 38. As a result, fluid flowing through the inflow passage 14 of the body 12 is effectively blocked from flowing through the inflow opening 40 by the plug 46. The movement of the plug 46 to its open position is facilitated by the upward linear movement of the plug 46 in any amount which is sufficient to cause the seating surface of the plug 46 to be elevated above the complimentary seating surface defined by the seat ring 38 when viewed from the perspective shown in FIG. 1. As will be recognized, such upward movement of the plug 46 facilitates the separation of the seating surface thereof from the seating surface of the seat ring 38, thus allowing fluid to flow from the inflow passage through the inflow opening 40.

Thus, when the plug 46 is moved to its open position, fluid is able to flow from the inflow passage 14 into the bore 44 of the flow control element 42. From within the bore 44, the fluid enters and flows radially outwardly through the tortuous and/or non-tortuous energy dissipating flow passageways of the flow control element 42 and into the gallery 18. After exiting the flow passageways of the flow control element 42 at the outer circumferential surface thereof, the fluid is able to flow into the outflow passage 16 defined by the body 12. As is apparent from the foregoing, this mode of operation is indicative of “under plug flow” as described above. As is a common characteristic of linear displacement valves, the degree of opening of the control valve 10 is variable, and based on the level of separation of the seating surface of the plug 46 from the seating surface of the seat ring 38. In this regard, the level of fluid flow through the flow control element 42, as well of the energy dissipating functionality thereof, is regulated by the number of flow passageways uncovered by the progressive movement of the seating surface of the plug 46 from the seating surface of the seat ring 38.

As also indicate above, based on the aforementioned description of fluid flow through the valve 10, such valve 10 is configured for under plug flow. However, those of ordinary skill in the art will recognize that valve 10 may also be configured for over plug flow without departing from the spirit and scope of the present invention. In an over plug flow condition, it is contemplated that the outflow passage 16 will become the inflow passage, with the inflow passage 14 becoming the outflow passage. In this regard, when the plug 46 is moved to its open position, fluid is able to flow from the inflow passage into the gallery 18, and thereafter radially inwardly through the tortuous and/or non-tortuous energy dissipating flow passageways of the flow control element 34, into the bore 44 thereof. From the bore 44, the fluid flows into the outflow passage via the opening 40 of the seat ring 38.

Those of ordinary skill in the art will recognize that various structural and functional attributes of the valve 10 may be varied from those described above without departing from the spirit and scope of the present invention. For example, the structural attributes of the body 12 and bonnet 20 may differ from those shown in FIG. 1. In this regard, the focal point of the present invention lies in the threaded interface of the stem 54 to the plug 46 such that the rotation of the stem 54 is converted to the linear movement of the plug 46, the integration of the anti-rotation keys 56 and wiper rings 58 into the plug 46, and the interface of the guide bushing 62/guide 66 to the plug 46. In addition, the plug 42 may be modified to include one or more balance holes functional in accordance with conventional principles, with the bonnet 20 being modified to include a vent port operative to prevent an undesirable pressure build-up within the valve 10 attributable to the reciprocation of the stem 54.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A control valve for regulating the flow of a fluid, the valve comprising:
a housing defining a fluid inlet and a fluid outlet;
a flow control element disposed within the housing between the fluid inlet and the fluid outlet, the flow control element being configured to dissipate energy in a fluid flowing therethrough from the fluid inlet to the fluid outlet;
a plug disposed within the housing and reciprocally moveable in a linear direction between closed and open positions relative thereto; and
a stem threadably engaged to plug such that the rotation of the stem facilitates the concurrent linear movement of the plug.

2. The control valve of claim 1 wherein:
the plug includes an internally threaded bore; and
the stem includes an externally threaded portion which is advanced into the bore.

3. The control valve of claim 2 wherein the plug further comprises at least one wiper ring disposed therein and protruding into the bore thereof into sliding contact with the stem.

4. The control valve of claim 1 wherein:
the plug includes at least one anti-rotation key disposed therein and protruding therefrom; and
the housing includes at least one groove formed therein which slidably accommodates a portion of the anti-rotation key in manner wherein the movement of the plug between its closed and open positions facilitates the concurrent movement of the anti-rotation key in the groove.

5. The control valve of claim 4 wherein the plug includes a pair of anti-rotation keys disposed therein in diametrically opposed relation to each other, the anti-rotation keys being received into respective ones of a diametrically opposed pair of grooves formed in the housing.

6. The control valve of claim 4 wherein:
the housing comprises a body which defines a gallery, and a bonnet which is attached to the body and defines a bore;
the flow control element is disposed within the gallery and the plug at least partially resides within the bore throughout the range of movement of the plug between the open and closed positions; and
the groove is formed within bonnet so as to extend at least partially along the bore thereof.

7. The control valve of claim 1 further comprising a bushing disposed within the housing and circumventing the plug, the bushing being fabricated from a first material, and including an annular guide which is slidably engaged to the plug and fabricated from a second material differing from the first material.

8. The control valve of claim 7 wherein the second material is PTFE.

9. The control valve of claim 1 wherein the flow control element is a unitary structure defining a multiplicity of tortuous and non-tortuous energy dissipating flow passageways.

10. The control valve of claim 1 further comprising a seat ring defining a flow opening which extends therethrough and a sealing surface which circumvents the flow opening, a portion of the plug and the sealing surface having complimentary configurations and being maintained in sealed engagement to each other when the plug is in the closed position.

11. The control valve of claim 2 wherein the internally threaded bore of the plug and the externally threaded portion of the stem comprise ACME threads.

12. A control valve for regulating the flow of a fluid, the valve comprising:
a housing;
a flow control element disposed within the housing and configured to dissipate energy in a fluid flowing therethrough;
a plug disposed within the housing and reciprocally moveable in a linear direction between closed and open positions relative thereto;
a stem threadably engaged to plug such that the rotation of the stem facilitates the concurrent linear movement of the plug;
at least one anti-rotation key disposed in the plug and protruding therefrom; and
at least one groove formed in the housing which slidably accommodates a portion of the anti-rotation key in manner wherein the movement of the plug between its closed and open positions facilitates the concurrent movement of the anti-rotation key in the groove.

13. The control valve of claim 12 wherein:
the plug includes an internally threaded bore; and
the stem includes an externally threaded portion which is advanced into the bore.

14. The control valve of claim 13 wherein the plug further comprises at least one wiper ring disposed therein and protruding into the bore thereof into sliding contact with the stem.

15. The control valve of claim 13 wherein the internally threaded bore of the plug and the externally threaded portion of the stem comprise ACME threads.

16. The control valve of claim 12 wherein the plug includes a pair of anti-rotation keys disposed therein in diametrically opposed relation to each other, the anti-rotation keys being received into respective ones of a diametrically opposed pair of grooves formed in the housing.

17. The control valve of claim 12 further comprising a bushing disposed within the housing and circumventing the plug, the bushing being fabricated from a first material, and including an annular guide which is slidably engaged to the plug and fabricated from a second material differing from the first material.

18. The control valve of claim 17 wherein the second material is PTFE.

19. The control valve of claim 12 wherein the flow control element is a unitary structure defining a multiplicity of tortuous and non-tortuous energy dissipating flow passageways.

20. The control valve of claim 12 further comprising a seat ring defining a flow opening which extends therethrough and a sealing surface which circumvents the flow opening, a portion of the plug and the sealing surface having complimentary configurations and being maintained in sealed engagement to each other when the plug is in the closed position.
